(19) United States
(12) Patent Application Publication
(10) Pub. No.: US 2018/0181371 A1
(43) Pub. Date: Jun. 28, 2018

(54) DATA THROTTLING FOR HIGH SPEED COMPUTING DEVICES

(71) Applicant: Intel Corporation, Santa Clara, CA (US)

(72) Inventors: Satheesh Chellappan, Folsom, CA (US); Hardik Shah, Folsom, CA (US)

(73) Assignee: Intel Corporation, Santa Clara, CA (US)

(21) Appl. No.: 15/391,911

(22) Filed: Dec. 28, 2016

(51) Int. Cl. G06F 5/06; H04L 29/08; H04L 12/879; H04L 12/26; G06F 5/14

(52) U.S. Cl. CPC G06F 5/065; H04L 67/141; H04L 49/901; G06F 2205/067; G06F 5/14; G06F 2205/126; H04L 43/50

(57) ABSTRACT

In one embodiment, an apparatus comprises an input output controller. The input output controller is configured to establish a connection between a host computing device and an external device. The input output controller is further configured to determine that the external device is operating using a slower data transmission speed than the input output controller. The input output controller is further configured to throttle data received from the external device.

### FIELD OF THE SPECIFICATION

This disclosure relates in general to the field of computer systems, and more particularly, though not exclusively, to data throttling for computing devices.

### BACKGROUND

Computing systems may include many different types of input/output (I/O) subsystems that use different protocols and/or operate at different speeds. Accordingly, in some cases, a particular computing system may not be compatible with other devices that do not support a particular I/O protocol or do not operate at a particular I/O speed or bandwidth.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example embodiment of a system for high speed device testing using data throttling.

FIG. 2 illustrates an example embodiment of a data throttle for a high speed device.

FIG. 3 illustrates an example state machine for data throttling performed on a high speed device.

FIG. 4 illustrates an example timing diagram for data throttling performed on a high speed device.

FIG. 5 illustrates a flowchart for an example embodiment of data throttling for a high speed device.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Example embodiments that may be used to implement the functionality of this disclosure will now be described with more particular reference to the attached FIGURES.

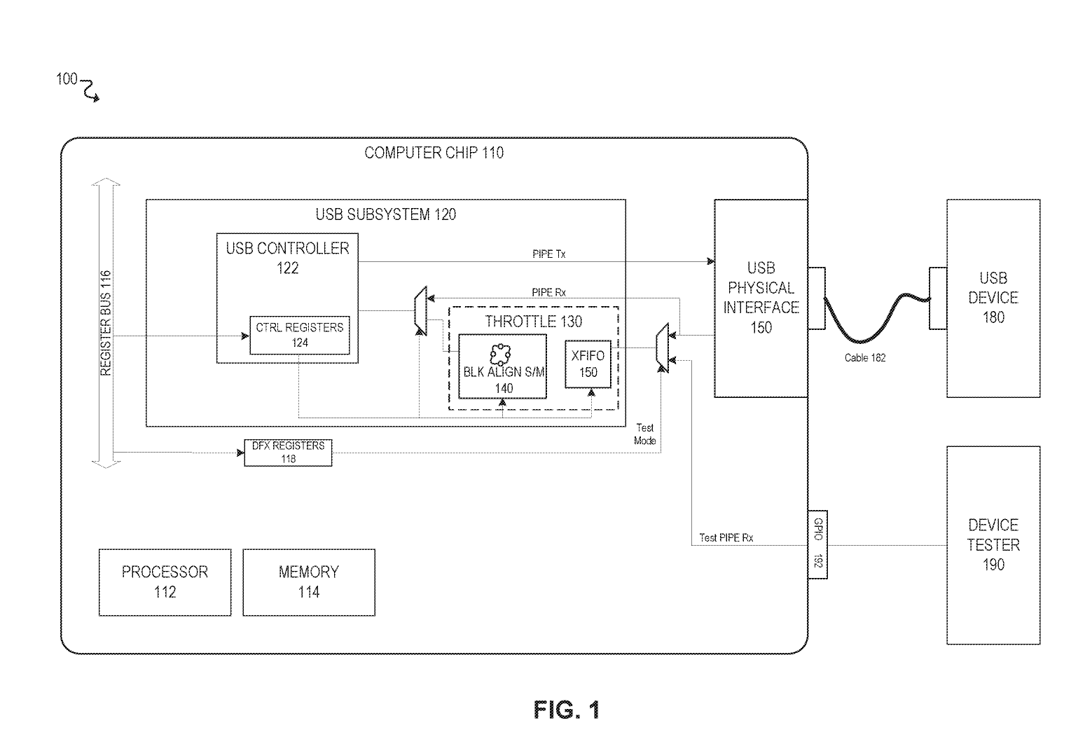

FIG. 1 illustrates an example embodiment of a system 100 for high speed device testing using data throttling. In some embodiments, for example, the device testing and data throttling functionality described throughout this disclosure may be implemented by components of system 100, as described further below.

In the illustrated embodiment, system 100 includes computer chip 110, USB device 180, and device tester 190. Computer chip 110 may be any suitable computing chip or device. In some embodiments, for example, computer chip 110 may be an integrated circuit, semiconductor chip, microprocessor, microcontroller, and/or any other electronic component or combination of electronic components. For example, in some embodiments, computer chip 110 may be a system-on-a-chip (SoC) that integrates various components of a computer or other electronic system into a single chip. In some embodiments, computer chip 110 may be associated with a computer, workstation, server, mainframe, virtual machine, embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data.

In the illustrated embodiment, computer chip 110 includes processor 112, memory 114, universal serial bus (USB) subsystem 120, USB physical interface 160, and register bus 116.

Processor 112 may include any combination of logic or processing elements operable to execute instructions, whether loaded from memory or implemented directly in hardware, such as a microprocessor, digital signal processor, field-programmable gate array (FPGA), graphics processing unit (GPU), programmable logic array (PLA), or application specific integrated circuit (ASIC), among other examples. Moreover, in some embodiments, processor 112 may be a multi-core processor that comprises a plurality of processor cores.

Memory 114 may include any component or mechanism capable of storing data, including any type or combination of volatile and/or non-volatile storage, such as random access memory (RAM) (e.g., dynamic random access memory (DRAM), synchronous dynamic random access memory (SDRAM), static random access memory (SRAM)), read only memory (ROM), logic blocks of a field programmable gate array (FPGA), erasable programmable read only memory (EPROM), electrically erasable programmable ROM (EEPROM), and/or any suitable combination of the foregoing.

USB subsystem 120 may be any controller or collection of components (e.g., a microcontroller) configured to facilitate communication with peripheral devices (e.g., USB device 180) using a USB-based connectivity specification. For example, USB subsystem 120 may enable communication with peripheral devices through USB physical interface 160.

USB physical interface 160 may be a communication interface for connecting a peripheral device (e.g., USB device 180) to computer chip 110 using a USB-compatible connector. USB physical interface 160, for example, may be used to connect any USB compatible device, including displays, mice, keyboards, printers, external storage, network controllers, cameras, microphones, speakers, sensors, and actuators, among other examples.

Register bus 116 may be a communication bus for communicating with memory registers of computer chip 110. For example, in some embodiments, register bus 116 may be used to facilitate communication to and from control registers 124 of USB controller 122, and DFX registers 118. For example, in some embodiments, control registers 124 may be used to control the I/O throttling functionality described below (e.g., by enabling or disabling throttling, configuring certain throttling parameters, and so forth). Similarly, DFX registers 118 may be used to transition the computer chip 110 between functional mode and test mode, as described below. Register bus 116 may include any interconnection fabric, bus, line, network, or other communication medium operable to carry data, signals, and/or power among electronic components. Moreover, in some embodiments, register bus 116 may comprise multiple interconnected buses or switching fabrics.

USB device 180 may be any USB-compatible peripheral device, including displays, mice, keyboards, printers, external storage, network controllers, cameras, microphones, speakers, sensors, and actuators, among other examples. In the illustrated embodiment, USB device 180 is connected to computer chip 110 using USB cable 182.

Device tester 190 may be an external device used for testing computer chip 110. In some cases, for example, device tester 190 may be used for high volume manufacturing (HVM) testing of computer chips. Device tester 190 may be used, for example, to test input/output (I/O) subsystems of computer chip 110 (e.g., USB subsystem 120) to ensure they function properly. In the illustrated embodiment, device tester 190 is connected to computer chip 110 through general purpose input output (GPIO) pins 192.

System 100 of FIG. 1 may be used to implement the device testing functionality described throughout this disclosure. For example, system 100 may facilitate high volume manufacturing (HVM) and testing of a computing device, such as computer chip 110. In particular, system 100 may facilitate detection of faulty computer chips 110 during the manufacturing stage. For example, device tester 190 of system 100 may be used to test the I/O subsystems of a particular computing device, such as the I/O subsystems of computer chip 110. In the illustrated embodiment, for example, device tester 190 may be used to test the USB subsystem 120 of computer chip 110. However, device tester 190 can also be used to test any other type of I/O subsystem of a computer chip 110 (e.g., peripheral component interconnect express (PCIe), serial advanced technology attachment (SATA), Gigabit Ethernet, and so forth).

In some cases, however, a device tester 190 may only be capable of testing devices and I/O subsystems that operate within a particular speed. Accordingly, such device testers 190 may be unable to effectively test high speed devices and I/O subsystems that operate above a particular speed, such as 8 Gbps and higher. Although a new type of device tester with the capability to test such high speed devices could be developed or used, such device testers can be very expensive, and thus developing and/or replacing existing device testers can be a costly approach. Accordingly, an alternative approach is to design the high speed devices that are being manufactured and tested (e.g., computer chip 110) with the ability to operate at a scaled down I/O speed or bandwidth, for example, using I/O throttling functionality. In this manner, the high speed devices can still be tested using an existing device tester 190 by scaling down their speed to a particular speed that is compatible with the existing device tester 190. The I/O throttling functionality can also be used for other purposes. For example, certain peripheral devices may support a particular I/O protocol used by a high speed computing device, but may not support the physical I/O speed of the computing device. Accordingly, I/O throttling can be used to allow a high speed computing device to operate at a particular speed supported by the peripheral device. For example, in system 100, computer chip 110 could perform I/O throttling in order to operate at a slower speed that is compatible with USB device 180. Accordingly, in some embodiments, I/O throttling functionality may be implemented with multiple modes used for different purposes. For example, in some embodiments, I/O throttling functionality may include a test mode used for device testing, and a functional mode used for providing compatibility with certain peripheral devices.

In the illustrated embodiment of FIG. 1, the USB subsystem 120 of computer chip 110 is implemented with I/O throttling functionality. For example, USB subsystem 120 includes I/O throttle 130 to perform I/O throttling for USB subsystem 120. In some embodiments, for example, I/O throttle 130 could be used to perform I/O throttling for a USB 3.1 subsystem. In the illustrated example, throttle 130 includes block alignment state machine 140 and XFIFO 150. Block alignment state machine 140 is a state machine used to implement I/O throttling functionality. XFIFO 150 is a first in, first out (FIFO) buffer used by block alignment state machine 140 to provide clock-crossing functionality for performing I/O throttling. These components are collectively used to allow USB subsystem 120 to perform I/O throttling functionality, as described further in connection with the remaining FIGURES. Moreover, although the illustrated embodiment implements I/O throttling functionality in USB subsystem 120, other embodiments may implement I/O throttling functionality for any type of I/O subsystem of a computing device, including PCIe, SATA, Gigabit Ethernet, and so forth.

The I/O throttling functionality described throughout this disclosure provides numerous technical advantages, including the ability to test high speed computing devices using existing device testers that are incompatible with high I/O speeds, thus avoiding the expense of replacing the existing device testers, and accordingly improving the high volume manufacturing (HVM) and testing process. Moreover, the I/O throttling functionality may provide compatibility between a high speed computing device and certain peripheral devices that support a requisite I/O protocol, but not the physical I/O speed, used by the high speed computing device.

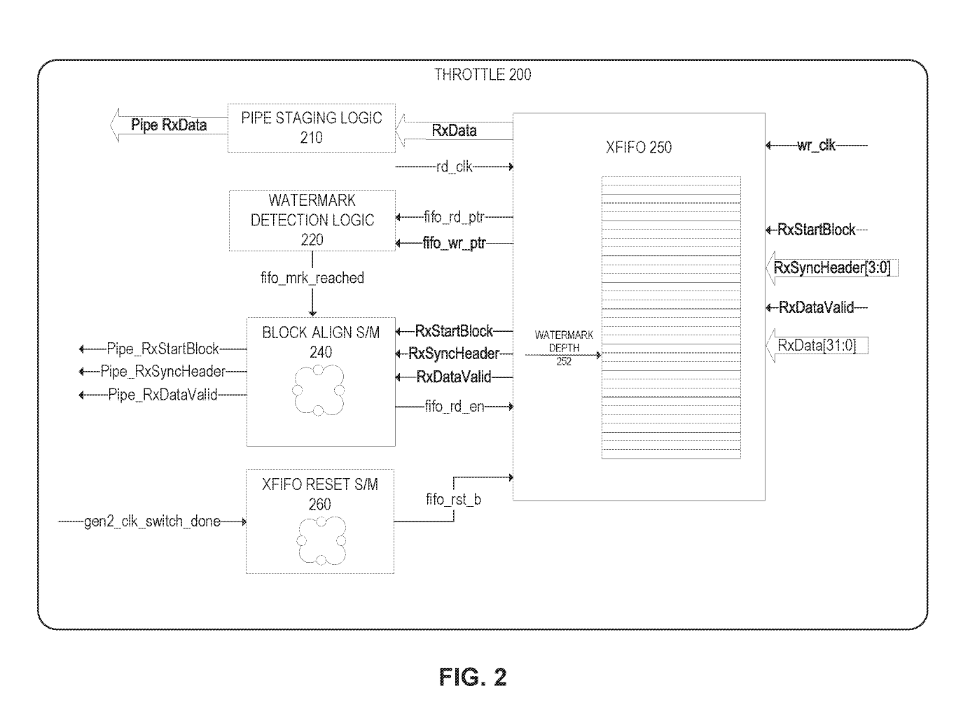

FIG. 2 illustrates an example embodiment of a data throttle 200 for a high speed device. Data throttle 200 may be used, for example, to implement data throttling for an I/O subsystem of a high speed computing device, such as USB subsystem 120 of computer chip 110 in FIG. 1.

As described further below, data throttle 200 is implemented using a clock crossing FIFO, or XFIFO 250, that supports both synchronous and asynchronous clock crossing, and includes buffer logic for throttling incoming data. For example, XFIFO 250 provides clock crossing between the PIPE interface of a host I/O controller and the PIPE receive interface for a peripheral device operating at a slower speed. In order to compensate for the slower speed, STALL operations are inserted in order to stall the PIPE interface of the host I/O controller. PIPE, for example, is a physical interface specification used by various I/O protocols, such as USB, PCIe, and SATA. XFIFO 250 is PIPE protocol aware and PIPE specification compliant (e.g., XFIFO 250 may be aware of, and compliant with, a particular PIPE protocol and specification, such as the PIPE 4.1 specification). XFIFO 250 resides on the PIPE receive path and is used to buffer data transmitted over the receive path, allowing it to accommodate slower clocking speeds than the standard clocking speed of 312.5 MHz. When data being written to XFIFO 250 reaches the FIFO watermark depth 252 of XFIFO 250, the data being read from XFIFO 250 is stalled at the particular block boundary. In this manner, a high speed computing device can be used with peripheral devices that operate at slower data rates, such as external testing devices or particular types of USB devices. Moreover, the devices can operate at throttled speeds while remaining fully compliant with the USB specification (e.g., for all defined layers (physical, link, protocol) and timers of the specification). This approach is also backwards compatible with peripheral devices that do not require data throttling. For example, in some cases, a high speed computing device may enable data throttling only for particular peripheral devices that are identified in a whitelist of devices that require data throttling.

In the illustrated embodiment, data throttle 200 includes pipe staging logic 210, watermark detection logic 220, block alignment state machine 240, XFIFO 250, and XFIFO reset state machine 260.

As noted above, XFIFO 250 is a clock crossing first in, first out (FIFO) buffer used for both synchronous and asynchronous clock crossing, and can be implemented using a configurable width and depth. The width, for example, can be chosen based on the PIPE data width. Moreover, XFIFO 250 includes a configurable watermark depth 252 used as a throttling threshold to determine when to stall data that is being read out of XFIFO 250. In some embodiments, the watermark depth 252 (and/or other configuration parameters) can be configured through a memory-mapped I/O (MMIO) register.

Block alignment state machine 240 is a state machine used to implement the throttling logic. For example, this state machine monitors the receive start block signal (RxStartBlock) from XFIFO 250 to identify the start of a block that is being received, and then it tracks that block until the end of the block is received. At the end of the block, this state machine checks for the FIFO watermark reached condition (fifo_mrk_reached) to determine whether to stall the PIPE interface of the host I/O controller. However, if the host I/O controller is already operating at the appropriate speed for the particular I/O device (e.g., at a slower 1^{st} generation speed), the stalling functionality is bypassed.

Watermark detection logic 220 compares the FIFO read pointer (fifo_rd_ptr) and the FIFO write pointer (fifo_wr_ptr) of XFIFO 250 to determine if the amount of data in XFIFO 250 exceeds the configured watermark depth 252.

XFIFO reset state machine 260 is used to update the state of XFIFO 250 from inactive to active (and vice versa), as appropriate. For example, this state machine may activate XFIFO 250 when the host I/O controller switches from a compatible slower speed to an incompatible faster speed (e.g., switching from a 1^{st} generation speed to a 2^{nd} generation speed), or when the host I/O controller switches from an inactive or low power state to an active state (e.g., when a USB controller switches from any of its low power states U1/U2/U3 to its active state U0). In some embodiments, for example, XFIFO reset state machine 260 may include an IDLE state, a WAIT FIFO EMPTY state, and an ASSERT RESET state. The IDLE state is the default state of this state machine. The state machine enters the IDLE state upon a reset assertion for XFIFO buffer 250, and remains in the IDLE state until a connected USB device completes a speed negotiation that switches the clock of the host I/O controller to a high speed frequency (e.g., a super speed plus frequency). When the clock is switched to a high speed frequency, the state machine enters the WAIT FIFO EMPTY state, where it remains until the remaining data is drained from XFIFO 250. Once XFIFO 250 is empty, the state machine enters the ASSERT RESET state. In the ASSERT RESET state, a FIFO reset (fifo_rst_b) is asserted to reset the FIFO read pointer (fifo_rd_ptr) and FIFO write pointer (fifo_wr_ptr) to their default values. The FIFO reset signal (fifo_rst_b) is asserted for 3 clock cycles, and the state machine then enters the IDLE state.

PIPE staging logic 210 provides staging logic for the PIPE receive data (Pipe_RxData) of the host I/O controller. PIPE staging logic 210 also resets the PIPE receive data (Pipe_RxData) during a STALL operation.

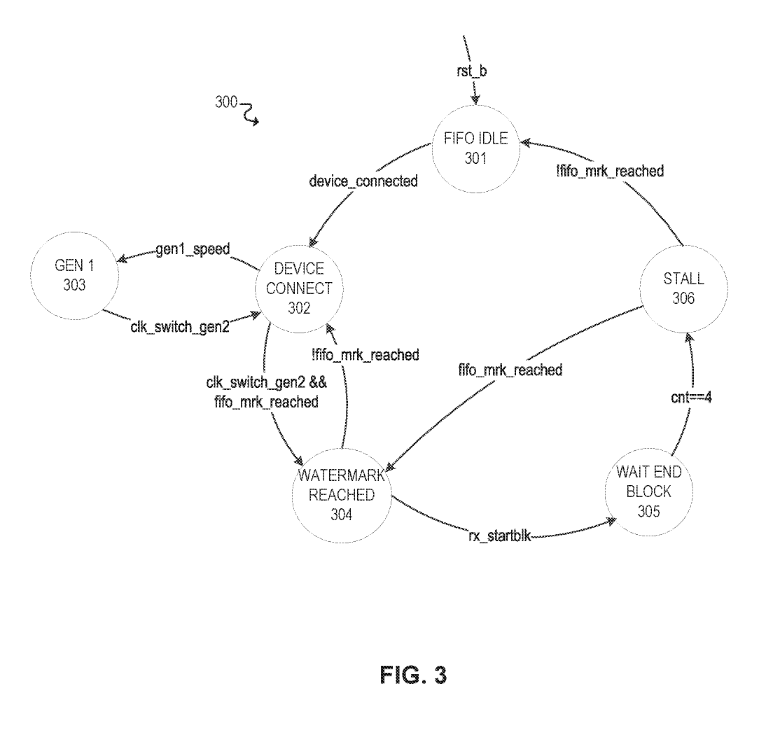

FIG. 3 illustrates an example state machine 300 for data throttling performed on a high speed device. In some embodiments, for example, state machine 300 may be used to implement block alignment state machine 240 of FIG. 2.

The FIFO IDLE state 301 of state machine 300 is the default state of this state machine. The state machine enters this state upon a reset assertion, and remains in this state until a peripheral device is connected to the host device. Upon a successful device connection, state machine 300 transitions to the DEVICE CONNECT state 302.

In the DEVICE CONNECT state 302, state machine 300 determines whether the connected device is operating at the speed supported by 1^{st} generation USB interfaces (e.g., SuperSpeed) or the speed supported by 2^{nd} generation USB interfaces (e.g., SuperSpeed Plus). If the particular device is connected using the 1^{st} generation speed, state machine 300 transitions to the GEN1 state 303, and remains in that state unless and until the device subsequently transitions to the 2^{nd} generation speed, at which point state machine 300 transitions back to the DEVICE CONNECT 302 state.

If the particular device is connected using the 2^{nd} generation speed, state machine 300 remains in the DEVICE CONNECT 302 state until the FIFO write pointer (fifo_wr_ptr) reaches the FIFO watermark. Once the FIFO watermark is reached, state machine 300 transitions to the WATERMARK REACHED state 304.

In the WATERMARK REACHED state 304, a FIFO read enable signal (fifo_rd_en) is asserted to cause data to be read out of the XFIFO buffer. In the WATERMARK REACHED state 304, once the difference between the FIFO read pointer (fifo_rd_ptr) and the FIFO write pointer (fifo_wr_ptr) is less than the FIFO watermark depth, state machine 300 transitions back to the DEVICE CONNECT state 302, where it remains until the FIFO watermark is reached again. Moreover, in the WATERMARK REACHED state 304, when a new data block starts being read out (as indicated by rx_startblock), state machine 300 transitions to the WAIT END BLOCK 305 state.

In the WAIT END BLOCK 305 state, state machine 300 remains in that state for 4 clock cycles, which is the length of a data block, and then state machine 300 transitions to the STALL state 306.

In the STALL state 306, state machine 300 de-asserts the FIFO read enable signal (fifo_rd_en) in order to stall the reading of data from the XFIFO buffer. Once enough data is written into the XFIFO buffer such that the FIFO watermark is reached, state machine 300 transitions back to the WATERMARK REACHED state 304 and re-asserts the FIFO read enable signal (fifo_rd_en) to resume reading data from the XFIFO buffer.

Once all the data has been drained from the XFIFO buffer (e.g., after a device tester completes a particular test of the host device), state machine 300 transitions back to the FIFO IDLE state 301.

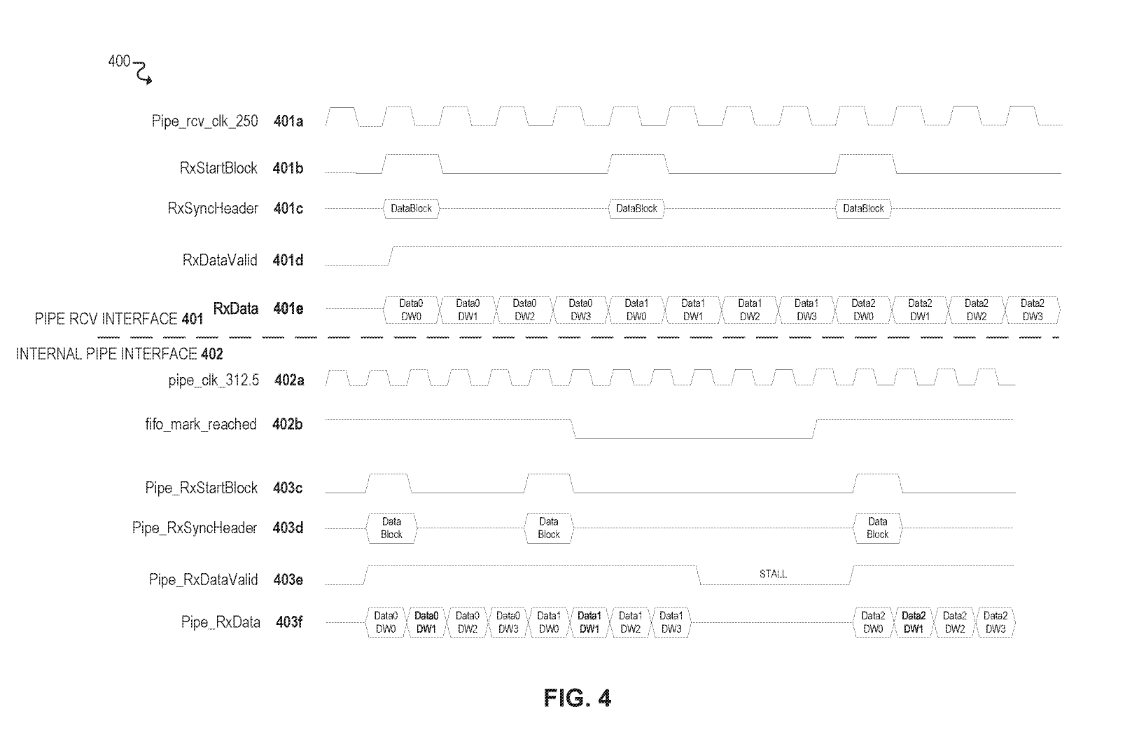

FIG. 4 illustrates an example timing diagram 400 for data throttling performed on a high speed device. Timing diagram 400 illustrates various waveforms and their respective relationships for the signals used in a particular embodiment of data throttling. For example, timing diagram 400 illustrates the waveforms associated with the PIPE receive interface 401 used for incoming data from a peripheral device (e.g., which is operating at a slower speed than the host device), and the internal PIPE interface 402 used for outgoing data sent by a host I/O controller.

The waveforms of PIPE receive interface 401 represent the respective signals when PIPE receive interface 401 is operating at a slower speed than internal PIPE interface 402. The waveforms of internal PIPE interface 402 represent the respective signals when internal PIPE interface 402 is operating at a faster speed than PIPE receive interface 401, and thus when STALLS are inserted in order to align the speeds of the respective interfaces.

The illustrated waveforms for PIPE receive interface 401 include the pipe_rcv_clk_250 signal 401a (e.g., the PIPE receive clock signal at 250 MHz), the RxStartBlock signal 401b (e.g., the receive start block signal), the RxSyncHeader signal 401c (e.g., the receive synchronization header signal), the RxDataValid signal 401d (e.g., the receive data valid signal), and the RxData signal 401e (e.g., the receive data signal).

The illustrated waveforms for internal PIPE interface 402 include the pipe_clk_312.5 signal 402a (e.g., the PIPE clock signal at 312.5 MHz), the fifo_mark_reached signal 402b (e.g., the FIFO watermark reached signal), the Pipe_RxStartBlock signal 402c (e.g., the PIPE receive start block signal), the Pipe_RxSyncHeader signal 402d (e.g., the PIPE receive synchronization header signal), the Pipe_RxDataValid signal 402e (e.g., the PIPE receive data valid signal), and the Pipe_RxData signal 402f (e.g., the PIPE receive data signal).

These various waveforms, for example, may represent the respective signals from the data throttling embodiments described throughout this disclosure.

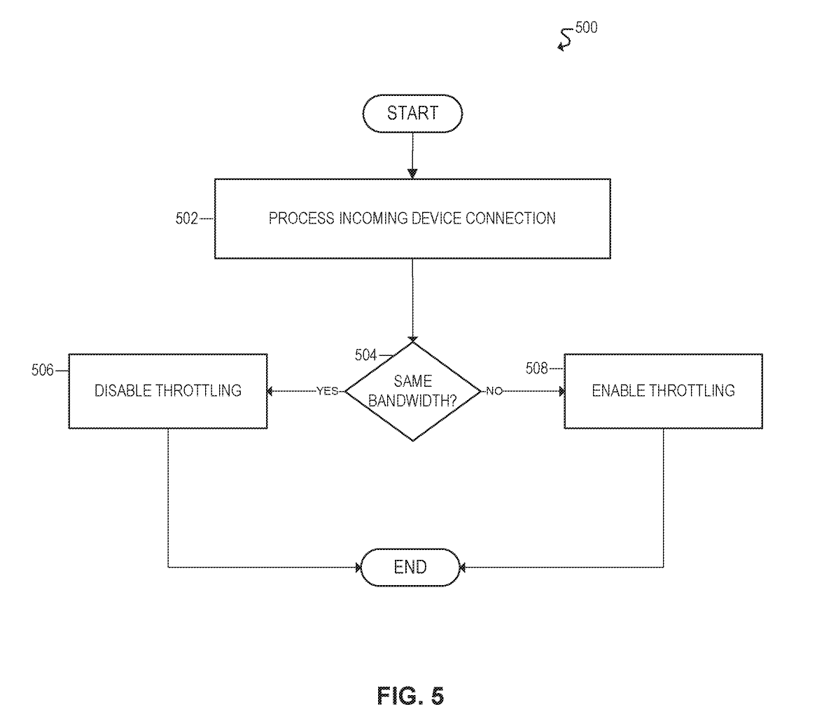

FIG. 5 illustrates a flowchart 500 for an example embodiment of data throttling for a high speed device. Flowchart 500 may be implemented, in some embodiments, by components described throughout this disclosure (e.g., components illustrated and/or described in connection with FIGS. 1-4).

The flowchart may begin at block 502 by processing or establishing an incoming connection from an external device. For example, a host computing device may process a connection from an external device, such as an external testing device or a particular USB device.

The flowchart may then proceed to block 504 to determine whether the external device is operating using the same data transmission speed as the host device. In some cases, for example, the host computing device may be capable of operating at faster I/O speeds than the external device. The host computing device, for example, may include a USB subsystem capable of operating at the speed supported by 2nd generation USB interfaces (e.g., SuperSpeed Plus). A particular external device, however, may either be operating at the speed supported by 1st generation USB interfaces (e.g., SuperSpeed), or the speed supported by 2nd generation USB interfaces (e.g., SuperSpeed Plus).

If it is determined at block 504 that the external device is operating using the same data transmission speed as the host device, the flowchart may then proceed to block 506, where the data throttling functionality of the host device is disabled and a normal connection is established.

If it is determined at block 504 that the external device is NOT operating using the same data transmission speed as the host device, the flowchart may then proceed to block 508 to enable data throttling on the host device. Data throttling, for example, may allow the host device to throttle the data transmitted between the host device and the external device. For example, in some cases, the external device may be operating using a slower data transmission speed than the host device. Accordingly, the data transmitted between the host device and the external device may need to be throttled in order to compensate for the different transmission speeds.

In some embodiments, for example, data throttling may be implemented using a clock crossing FIFO buffer, or XFIFO, that supports both synchronous and asynchronous clock crossing, and includes buffer logic for throttling incoming data. For example, the XFIFO buffer enables clock crossing between the PIPE interface of the host I/O controller and the PIPE receive interface for the external device operating at a slower speed. In order to compensate for the slower speed, STALL operations are inserted in order to stall the PIPE interface of the host I/O controller. The XFIFO buffer resides on the PIPE receive path and is used to buffer data transmitted over the receive path, allowing it to accommodate slower clocking speeds than the standard clocking speed of 312.5 MHz. When data being written to the XFIFO buffer reaches the FIFO watermark depth, the data being read from the XFIFO buffer is stalled at the particular block boundary. In this manner, a high speed computing device can be used with peripheral devices that operate at slower data rates, such as external testing devices or particular types of USB devices. This approach is also backwards compatible with peripheral devices that do not require data throttling. For example, in some cases, a high speed computing device may enable data throttling only for particular peripheral devices that are identified in a whitelist of devices that require data throttling.

At this point, the flowchart may be complete. In some embodiments, however, the flowchart may restart and/or certain blocks may be repeated. For example, in some embodiments, the flowchart may restart at block 502 to continue processing connection requests and throttling data, as needed.

The flowcharts and block diagrams in the FIGURES illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing disclosure outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

As used throughout this specification, the term “processor” or “microprocessor” should be understood to include not only a traditional microprocessor (such as Intel's® industry-leading x86 and x64 architectures), but also graphics processors, and any ASIC, FPGA, microcontroller, digital signal processor (DSP), programmable logic device, programmable logic array (PLA), microcode, instruction set, emulated or virtual machine processor, or any similar “Turing-complete” device, combination of devices, or logic elements (hardware or software) that permit the execution of instructions.

Note also that in certain embodiments, some of the components may be omitted or consolidated. In a general sense, the arrangements depicted in the figures should be understood as logical divisions, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute instructions associated with data or microcode to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage may store information in any suitable type of tangible, non-transitory storage medium (for example, random access memory (RAM), read only memory (ROM), field programmable gate array (FPGA), erasable programmable read only memory (EPROM), electrically erasable programmable ROM (EEPROM), or microcode), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein should be construed as being encompassed within the broad terms ‘memory’ and ‘storage,’ as appropriate. A non-transitory storage medium herein is expressly intended to include any non-transitory special-purpose or programmable hardware configured to provide the disclosed operations, or to cause a processor to perform the disclosed operations. A non-transitory storage medium also expressly includes a processor having stored thereon hardware-coded instructions, and optionally microcode instructions or sequences encoded in hardware, firmware, or software.

Computer program logic implementing all or part of the functionality described herein is embodied in various forms, including, but in no way limited to, hardware description language, a source code form, a computer executable form, machine instructions or microcode, programmable hardware, and various intermediate forms (for example, forms generated by an HDL processor, assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

Example Implementations

The following examples pertain to embodiments described throughout this disclosure.

One or more embodiments may include an apparatus, comprising: an input output controller to: establish a connection between a host computing device and an external device; determine that the external device is operating using a slower data transmission speed than the input output controller; and throttle data received from the external device.

In one example embodiment of an apparatus, the apparatus further comprises a FIFO buffer to store the data received from the external device.

In one example embodiment of an apparatus, the FIFO buffer comprises a clock crossing FIFO buffer.

In one example embodiment of an apparatus, the input output controller is further configured to stall data from being read from the FIFO buffer when data stored in the FIFO buffer is below a threshold.

In one example embodiment of an apparatus, the threshold is configurable using a control register.

In one example embodiment of an apparatus: the FIFO buffer comprises a write pointer and a read pointer; and the input output controller is further configured to determine that the data stored in the FIFO buffer is below the threshold based on a location of the write pointer and a location of the read pointer.

In one example embodiment of an apparatus, the input output controller is associated with a universal serial bus subsystem.

In one example embodiment of an apparatus, the external device comprises a universal serial bus device.

In one example embodiment of an apparatus, the external device comprises an external testing device.

In one example embodiment of an apparatus, the external testing device is for testing the input output controller.

In one example embodiment of an apparatus, the input output controller is further configured to enable a test mode for throttling data of an external testing device.

In one example embodiment of an apparatus, the test mode is configurable using a control register.

In one example embodiment of an apparatus, the input output controller is further configured to enable a functional mode for throttling data of a universal serial bus device.

In one example embodiment of an apparatus, the functional mode is configurable using a control register.

One or more embodiments may include a method, comprising: establishing a connection between a host computing device and an external device; determining that the external device is operating using a slower data transmission speed than an input output controller of the host computing device; and throttling data received from the external device.

In one example embodiment of a method, the method further comprises storing the data received from the external device in a FIFO buffer.

In one example embodiment of a method, the method further comprises stalling data from being read from the FIFO buffer when data stored in the FIFO buffer is below a threshold.

In one example embodiment of a method, the threshold is configurable using a control register.

In one example embodiment of a method, the method further comprises determining that the data stored in the FIFO buffer is below the threshold based on a location of a FIFO write pointer and a location of a FIFO read pointer.

In one example embodiment of a method, the external device comprises an external testing device for testing the input output controller.

In one example embodiment of a method, the method further comprises: enabling a test mode for throttling data of an external testing device; or enabling a functional mode for throttling data of a universal serial bus device.

One or more embodiments may include a system, comprising: a processor; and an input output controller to: establish a connection between a host computing device and an external device; determine that the external device and the input output controller are operating using a same data transmission speed; and disable throttling for data received from the external device.

In one example embodiment of a system, the input output controller is further configured to: determine that the external device is operating using a slower data transmission speed than the input output controller; and enable throttling for data received from the external device.

One or more embodiments may include at least one machine accessible storage medium having instructions stored thereon, the instructions, when executed on a machine, cause the machine to: establish a connection between a host computing device and an external device; determine that the external device is operating using a slower data transmission speed than an input output controller of the host computing device; and throttle data received from the external device.

In one example embodiment of a storage medium, the instructions further cause the machine to: store the data received from the external device in a FIFO buffer; and stall data from being read from the FIFO buffer when data stored in the FIFO buffer is below a threshold.

One or more embodiments may include an apparatus comprising means to perform a method from any of the preceding examples.

One or more embodiments may include at least one machine accessible storage medium having instructions stored thereon, the instructions when executed on a machine, cause the machine to perform a method or realize an apparatus from any of the preceding examples.

1. An apparatus, comprising:
an input output controller to:
establish a connection between a host computing device and an external device;
determine that the external device is operating using a slower data transmission speed than the input output controller; and
throttle data received from the external device to:
store the data received from the external device in a FIFO buffer;
determine that a threshold for the FIFO buffer has been met;
read the data from the FIFO buffer for four clock cycles based on the determination; and
stall the data from being read from the FIFO buffer following the four clock cycles when the data stored in the FIFO buffer is below the threshold.

2. (canceled)

3. The apparatus of claim 1, wherein the FIFO buffer comprises a clock crossing FIFO buffer.

4. (canceled)

5. The apparatus of claim 1 wherein the threshold is configurable using a control register.

6. The apparatus of claim 1:
wherein the FIFO buffer comprises a write pointer and a read pointer; and
wherein the input output controller is further configured to determine that the data stored in the FIFO buffer is below the threshold as the data is read from the FIFO buffer based on a location of the write pointer and a location of the read pointer.

7. The apparatus of claim 1, wherein the input output controller is associated with a universal serial bus subsystem.

8. The apparatus of claim 1, wherein the external device comprises a universal serial bus device.

9. The apparatus of claim 1, wherein the external device comprises an external testing device.

10. The apparatus of claim 9, wherein the external testing device is for testing the input output controller.

11. The apparatus of claim 1, wherein the input output controller is further configured to enable a test mode for throttling data of an external testing device.

12. The apparatus of claim 11, wherein the test mode is configurable using a control register.

13. The apparatus of claim 1, wherein the input output controller is further configured to enable a functional mode for throttling data of a universal serial bus device.

14. The apparatus of claim 13, wherein the functional mode is configurable using a control register.

15. A method, comprising:
establishing a connection between a host computing device and an external device;
determining that the external device is operating using a slower data transmission speed than an input output controller of the host computing device; and
throttling data received from the external device, wherein the throttling comprises:
storing the data received from the external device in a FIFO buffer;
determining that a threshold for the FIFO buffer has been met;
reading the data from the FIFO buffer for four clock cycles based on the determination; and
stalling the data from being read from the FIFO buffer following the four clock cycles when the data stored in the FIFO buffer is below the threshold.

16. (canceled)

17. (canceled)

18. The method of claim 15, wherein the threshold is configurable using a control register.

19. The method of claim 15, further comprising determining that the data stored in the FIFO buffer is below the threshold during the reading based on a location of a FIFO write pointer and a location of a FIFO read pointer.

20. The method of claim 15, wherein the external device comprises an external testing device for testing the input output controller.

21. The method of claim 15, further comprising:
enabling a test mode for throttling data of an external testing device; or
enabling a functional mode for throttling data of a universal serial bus device.

22. A system, comprising:
a processor; and
an input output controller to:
establish a connection between a host computing device and an external device;
determine that the external device and the input output controller are operating using a same data transmission speed;
disable throttling for data received from the external device based on a determination that the external device and the input output controller are operating using the same data transmission speed;
determine that the external device is operating using a slower data transmission speed than the input output controller; and
enable throttling for data received from the external device based on a determination that the external device is operating using a slower data transmission speed than the input output controller, wherein the throttling is to:
store the data received from the external device in a FIFO buffer;
determine that a threshold for the FIFO buffer has been met;
read the data from the FIFO buffer for four clock cycles based on the determination; and
stall the data from being read from the FIFO buffer following the four clock cycles when the data stored in the FIFO buffer is below the threshold.

23. (canceled)

24. At least one non-transitory machine accessible storage medium having instructions stored thereon, the instructions, when executed on a machine, cause the machine to:
establish a connection between a host computing device and an external device;
determine that the external device is operating using a slower data transmission speed than an input output controller of the host computing device; and
throttle data received from the external device to:
store the data received from the external device in a FIFO buffer;
determine that a threshold for the FIFO buffer has been met;
read the data from the FIFO buffer for four clock cycles based on the determination; and
stall the data from being read from the FIFO buffer following the four clock cycles when the data stored in the FIFO buffer is below the threshold.

25. (canceled)
